(19) United States
(12) Patent Application Publication
(10) Pub. No.: US 2008/0177529 A1
(43) Pub. Date: Jul. 24, 2008

(54) Voice-over device and method of use

(76) Inventor: Kristi Roberts, Lavon, TX (US)

Correspondence Address: JAMES RAY & ASSOCIATES, 2640 PITCAIRN ROAD, MONROEVILLE, PA, 15146, US

(21) Appl. No.: 12/009,920

(22) Filed: Jan. 23, 2008

Related U.S. Application Data
(60) Provisional application No. 60/886,348, filed on Jan. 24, 2007.

(51) Int. Cl. G06F 17/28

(52) U.S. Cl. 704/2

(57) ABSTRACT

In combination with a global positioning system receiver including a speech generating portion, the improvement comprising a voice-over device including a computerized data system, a storage mechanism for storing different voices, a selecting mechanism, a conversion mechanism, and a voice transmitting mechanism.

### CROSS REFERENCE TO RELATED APPLICATION

This patent application is related to and claims priority from U.S. Provisional Patent Application Ser. No. 60/886,348 filed Jan. 24, 2007.

### FIELD OF THE INVENTION

The present invention relates, in general, to voiceover devices and, more particularly, this invention relates to voice-over devices for use in connection with global positioning systems (GPS).

### BACKGROUND OF THE INVENTION

Prior to the conception and development of the present invention, voiceover devices, as are generally well known in the prior art, have been used to provide information to the public in a pleasing, controlled and socially acceptable manner. In particular global positioning systems use a computer generated voice to vocalize instructions to the operator of a motor vehicle. However, there is no system which provides vocalization by a computer system in an individualized manner.

Specifically of interest to the present invention are the following: Pazandak, et al, U.S. Pat. No. 7,027,975, discloses a guided natural language interface system and method by which a user inputs commands or queries into a computer system in natural language and the computer system responds.

Dietz, U.S. Pat. No. 6,385,586, discloses a method for providing language translations from a first human language into a second human language using a computerized system.

Rodriguez, et al, U.S. Pat. No. 6,985,753, discloses a a portable navigation and communication system including a speech recognition subsystem to provide a voice-activated, speech-controlled user interface for hands-free operation.

### SUMMARY OF THE INVENTION

In combination with a global positioning system receiver including a speech generating portion, the present invention provides a voice-over device including a computerized data system disposed within such receiver for receiving and transmitting data compatible with such global positioning system receiver. A storage means is operably connected to the computerized data system for storing at least one of a plurality of different voices, a plurality of different voices expressed in at least one of a particular language, a particular dialect, and a combination thereof. A selecting means is in communication with the storage means for selecting at least one of such plurality of different voices, such plurality of different voices expressed in at least one of such particular language, such particular dialect, and such combination thereof. A conversion means is in communication with such selecting means for converting a voice vocalizing words from a speech generating portion of such global positioning system, to such selection of at least one of such plurality of different voices, such plurality of different voices expressed in at least one of such particular language, such particular dialect, and such combination thereof. A voice transmitting means is in communication with such conversion means for transmitting at least one of such plurality of different voices expressed in at least one of such particular language, such particular dialect, and such combination thereof.

A method of utilizing a voice-over mechanism in a global positioning system comprising the steps of providing a computerized data system for receiving and transmitting data compatible with a global positioning system. Storing at least one of a plurality of different voices expressed in at least one of a particular language, a particular dialect, and a combination thereof. Selecting at least one of such plurality of different voices expressed in at least one of such particular language, such particular dialect, and such combination thereof, Converting a voice vocalizing words from a speech generating portion of such global positioning system, to such selection, and transmitting such selection of at least one of such plurality of different voices expressed in at least one of such particular language, such particular dialect, and such combination thereof to such global positioning system.

An apparatus for use in a global positioning system having a computerized data system for receiving and transmitting data, a means for storing data, a means for selecting data, and a means converting data, such apparatus comprising a means for uploading data into such global positioning system.

### OBJECTS OF THE INVENTION

It is, therefore, one of the primary objects of the present invention to provide a voice-over device that provides multi-cultural and multi-language voice options for use with global positioning systems.

Another object of the present invention is to provide a voice-over device that provides amusing and novel voice options for use with global positioning systems.

Still another object of the present invention is to provide a voice-over device that provides celebrity voice options for use with global positioning systems.

Yet another object of the present invention is to provide an inexpensive and novel item to make driving more enjoyable for all those in the vehicle.

Yet an additional object of the present invention is to provide a method of utilizing a voice-over mechanism in a global positioning system.

Still another object of the present invention is to provide a global positioning system which includes a plurality of amusing and novel voices, languages, and dialects from which a user may choose.

In addition to the various objects and advantages of the present invention described with some degree of specificity above it should be obvious that additional objects and advantages of the present invention will become more readily apparent to those persons who are skilled in the relevant art from the following more detailed description of the invention, particularly, when such description is taken in conjunction with the attached drawing figures and with the appended claims.

### BRIEF DESCRIPTION OF THE DRAWINGS

FIG. 1 is a schematic view of a voice-over device according to one embodiment of the invention.

FIG. 2 is a schematic view of a voice-over device according to one embodiment of the invention.

### BRIEF DESCRIPTION OF A PRESENTLY PREFERRED AND VARIOUS ALTERNATIVE EMBODIMENTS OF THE INVENTION

Prior to proceeding to the more detailed description of the present invention it should be noted that, for the sake of clarity and understanding, identical components which have identical functions have been identified with identical reference numerals throughout the several views illustrated in the drawing figures.

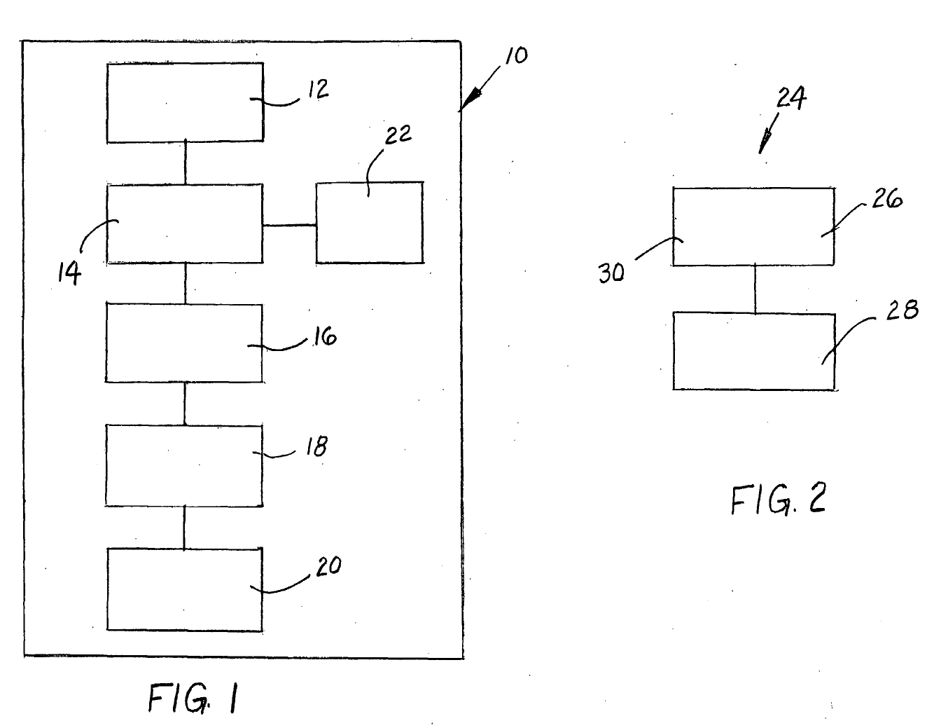

Reference is now made, more particularly, to FIGS. 1-2.

Illustrated in FIG. 1, in combination with a global positioning system receiver, generally designated 10, is a voice-over device. Such device includes a computerized data system 12 disposed within such receiver for receiving and transmitting data compatible with such global positioning system receiver. A storage means 14 is operably connected to such computerized data system 12 for storing at least one of a plurality of different voices, a plurality of different voices expressed in at least one of a particular language, a particular dialect, and a combination thereof.

A selecting means 16 is in communication with such storage means 14 for selecting at least one of such plurality of different voices, such plurality of different voices expressed in at least one of such particular language, such particular dialect, and such combination thereof.

A conversion means 18 is in communication with such selecting means 16 for converting a voice vocalizing words from a speech generating portion of such global positioning system to at least one of such plurality of different voices, such plurality of different voices expressed in at least one of such particular language, such particular dialect, and such combination thereof.

A voice transmitting means 20 is in communication with such conversion means 18 for transmitting at least one of such plurality of different voices, such plurality of different voices expressed in at least one of such particular language, such particular dialect, and such combination thereof.

In the presently preferred embodiment such device further includes a recording means 22 for recording a predetermined person's voice for vocalizing information generated by such global positioning system. It is presently most preferred that such predetermined person's voice is selected from at least one of a user's voice, a user's relative's voice, a user's friend's voice and a user's acquaintance's voice.

It is also presently preferred that such plurality of different voices includes at least one of celebrity voices, voices with ethnic accents, voices with foreign accents, voices with regional accents, and character voices. It is further presently preferred that such plurality of voices expressed in such particular dialect may include at least one of embellishments, slang, regional dialect, explicit language, foreign language, local vernacular, formal dialect, and informal dialect.

In another embodiment of the invention, a method of utilizing a voice-over mechanism in a global positioning system is provided. Such method includes providing a computerized data system for receiving and transmitting data compatible with a global positioning system. Storing at least one of a plurality of different voices expressed in at least one of a particular language, a plurality of different voices expressed in at least one of a particular dialect, and a combination thereof. Selecting at least one of such plurality of different voices expressed in at least one of such particular language, such particular dialect, and such combination thereof. Converting a voice vocalizing words from a speech generating portion of such global positioning system to such selection. Finally, transmitting such selection of at least one of such plurality of different voices expressed in at least one of such particular language, such particular dialect, and such combination thereof to such global positioning system.

It is presently preferred that such plurality of different voices includes at least one of celebrity voices, voices with ethnic accents, voices with foreign accents, voices with regional accents, and character voices. It is further presently preferred that such plurality of voices expressed in a particular dialect includes at least one of embellishments, slang, regional dialect, explicit language, foreign language, local vernacular, formal dialect, and informal dialect.

Yet another embodiment, as illustrated in FIG. 2, provides an apparatus, generally designated 24, which comprises a means 26 for uploading data into a global positioning system, generally designated 28. Such global position system 28 having a computerized data system for receiving and transmitting data, a means for storing data, a means for selecting data, and a means converting data. It is presently preferred that such means 26 for uploading data into such global positioning system is at least one of a computer processing unit and a compact data disk. It is further presently preferred that such data includes at least one of a plurality of different voices, a plurality of different voices expressed in at least one of a particular language, a particular dialect, and a combination thereof.

It is presently preferred that such apparatus further includes a recording means 30 for recording a predetermined person's voice for vocalizing information generated by such global positioning system 28. It is further presently preferred that such predetermined person's voice is selected from at least one of a user's voice, a user's relative's voice, a user's friend's voice and a user's acquaintance's voice.

In yet another embodiment of the invention, it is contemplated that such recording device can be retrofitted into an existing global positioning system.

While a presently preferred and various alternative embodiments of the present invention have been described in sufficient detail above to enable a person skilled in the relevant art to make and use the same it should be obvious that various other adaptations and modifications can be envisioned by those persons skilled in such art without departing from either the spirit of the invention or the scope of the appended claims.

I claim:

1. In combination with a global positioning system receiver including a speech generating portion, the improvement comprising a voice-over device including:
a. a computerized data system disposed within said receiver for receiving and transmitting data compatible with said global positioning system receiver;
b. a storage means operably connected to said computerized data system for storing at least one of a plurality of different voices, a plurality of different voices expressed in at least one of a particular language, a particular dialect, and a combination thereof;
c. a selecting means in communication with said storage means for selecting at least one of said plurality of different voices, said plurality of different voices expressed in said at least one of said particular language, said particular dialect, and said combination thereof;
d. a conversion means in communication with said selecting means for converting a voice vocalizing words from said speech generating portion of said global positioning system receiver, to at least one of said plurality of different voices, said plurality of different voices expressed in said at least one of said particular language, said particular dialect, and said combination thereof; and
e. a voice transmitting means in communication with said conversion means for transmitting at least one of said plurality of different voices expressed in said at least one of said particular language, said particular dialect, and said combination thereof.

2. A voice-over device according to claim 1 wherein said device further includes a recording means in communication with said storage means for recording a predetermined person's voice for vocalizing information generated by said global positioning system receiver.

3. A voice-over device according to claim 2 wherein said predetermined person's voice is selected from at least one of a user's voice, a user's relative's voice, a user's friend's voice and a user's acquaintance's voice.

4. A method of utilizing a voice-over mechanism in a global positioning system comprising the steps of:
a. providing a computerized data system for receiving and transmitting data compatible with a global positioning system;
b. storing at least one of a plurality of different voices, a plurality of different voices expressed in at least one of a particular language, a particular dialect, and a combination thereof;
c. selecting at least one of said plurality of different voices, said plurality of different voices expressed in said at least one of said particular language, said particular dialect, and said combination thereof;
d. converting a voice vocalizing words from a speech generating portion of said global positioning system, to at least one of said plurality of different voices, said plurality of different voices expressed in said at least one of said particular language, said particular dialect, and said combination thereof; and
e. transmitting at least one of said plurality of different voices, said plurality of different voices expressed in said at least one of said particular language, said particular dialect, and said combination thereof to said global positioning system.

5. A method of utilizing a voice-over mechanism in a global positioning system according to claim 4 wherein said plurality of different voices includes at least one of celebrity voices, voices with ethnic accents, voices with foreign accents, voices with regional accents, and character voices.

6. A method of utilizing a voice-over mechanism in a global positioning system according to claim 4 wherein said plurality of voices expressed in a particular dialect includes at least one of embellishments, slang, regional dialect, explicit language, foreign language, local vernacular, formal dialect, and informal dialect.

7. An apparatus for use in a global positioning system having a computerized data system for receiving and transmitting data, a means for storing data, a means for selecting data, and a means converting data, said apparatus comprising a means for uploading data into said global positioning system.

8. An apparatus according to claim 7 wherein said means for uploading data into said global positioning system is at least one of a computer processing unit and a compact data disk.

9. An apparatus according to claim 8 wherein said data includes at least one of a plurality of different voices expressed in at least one of a particular language, a plurality of voices expressed in at least one of a particular dialect, and a combination thereof.

10. The apparatus according to claim 7 wherein said apparatus further includes a recording means for recording a predetermined person's voice for vocalizing information generated by said global positioning system.

11. The apparatus according to claim 10 wherein said predetermined person's voice is selected from at least one of a user's voice, a user's relative's voice, a user's friend's voice and a user's acquaintance's voice.
